(19) United States
(12) Patent Application Publication
(10) Pub. No.: US 2026/0241884 A1
(43) Pub. Date: Aug. 20, 2026

(54) Vehicle Bumper with Light Module

(71) Applicant: OMIX-ADA, Inc., Ann Arbor, MI (US)

(72) Inventors: Elvis Isai Perez-Castro, Avondale Estates, GA (US); Eric Lance Russell, Lilburn, GA (US)

(21) Appl. No.: 19/544,723

(22) Filed: Feb. 19, 2026

Related U.S. Application Data
(60) Provisional application No. 63/760,464, filed on Feb. 19, 2025.

(51) Int. Cl. B60R 19/50; F21S 41/20

(52) U.S. Cl. CPC B60R 19/50; F21S 41/285; B60R 2019/505

(57) ABSTRACT

A vehicle bumper includes a bumper body having a first support, a second support laterally spaced from the from the first support and a cross body positioned between the first support and the second support. The vehicle bumper further includes a light module having a light source, a base, and a light transmissive section configured to transmit light emitted from the light source. A front bumper for a vehicle and an aftermarket front bumper also includes a bumper body and at least one light module.

### BACKGROUND

The present application relates to vehicle bumpers, and in particular, vehicle bumpers having a light module. In some embodiments, the vehicle bumper is installed on a vehicle as an aftermarket bumper.

A conventional bumper, such as an aftermarket bumper used for off-road or other rugged conditions, may partially obscure a vehicle light, such as a turn signal, depending on the viewing angle. In addition, in some conditions, e.g., low light, inclement weather, dusty, muddy, etc., the extent of the bumper may be difficult to see. Moreover, in such environments, it may be difficult for the operator to objects or obstacles in the vicinity of the vehicle.

### SUMMARY

Accordingly, it is desirable to improve visual indicators on a vehicle bumper. According to non-limiting embodiments described herein and shown in the drawings, in one aspect, a vehicle bumper includes a bumper body having a first support, a second support laterally spaced from the first support and a cross body positioned between the first support and the second support. A light module includes a light source, a base and a light transmissive section.

In another aspect, a front bumper for a vehicle includes a bumper body connected to the vehicle, a first light module at a first lateral end of the bumper body and a second light module at a second lateral end of the bumper body. The first and second light module each include a light source configured to emit light from the respective light module.

In still another aspect, an aftermarket front bumper for a vehicle is configured to be mounted to a front portion of the vehicle, the front bumper comprising a bumper body having an installation surface configured to accommodate installation on a corresponding surface of the vehicle and a light module removably connected to the bumper body. The light module includes a light transmissive section through which light is emitted. The light transmissive section forms less than all of an outer surface of the light module.

### BRIEF DESCRIPTION OF THE DRAWINGS

FIG. 1 is a perspective view of a bumper according to the present examples installed on a front portion of a vehicle;

FIG. 2 is a top view of the bumper of FIG. 1;

FIG. 3 is a front view of the bumper of FIG. 1 installed on a front portion of a vehicle;

FIG. 4 is a top perspective view of the bumper of FIG. 1;

FIG. 5 is a side view of the bumper of FIG. 1;

FIG. 6 is a perspective view of the bumper of FIG. 1 mounted on a vehicle according to one example;

FIG. 7 is a front view of the bumper of FIG. 1 mounted on a vehicle according to one example; and

FIG. 8 is a partial view of the bumper of FIGS. 1-5 mounted on a vehicle according to one example.

### DETAILED DESCRIPTION

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

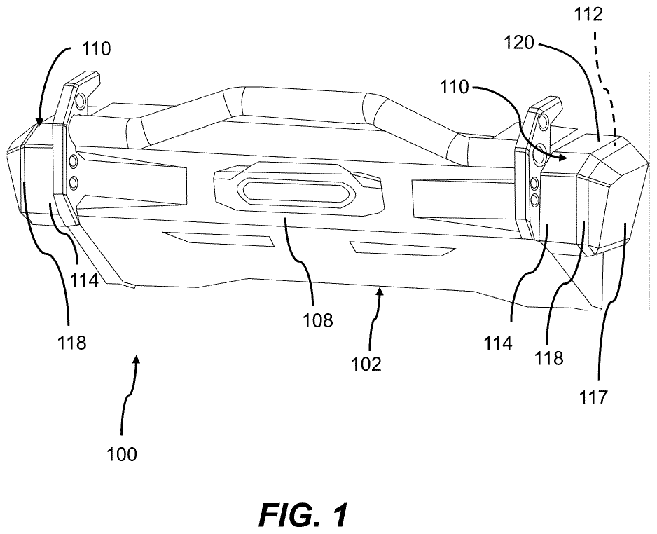

With general reference to FIG. 1, a vehicle bumper 100 includes a bumper body 102 having a first support 104, a second support 106 laterally spaced from the first support 104 and a cross body 108 positioned between the first support 104 and the second support 106. The vehicle bumper 100 also includes a light module 110 that may be arranged at one or more lateral ends of the bumper body 102, for example, at first and second supports 104, 106.

A light module 110 includes a light source 112, a base 114 and a light transmissive section 118 through which light emitted from the light source 112 may be transmitted. In one example, an outer surface of the base 114 and an outer surface of the light transmissive section 118 form an outer surface 120 of the light module 110.

The light transmissive section 118 may have different light transmission properties than the base 114. For example, the base 114 may be an opaque material and the light transmissive section 118 may include a transparent material or a translucent material. The light transmissive section 118 may include a light diffracting surface. In general, the base 114 allows less light transmission, if any at all, than the light transmissive section 118.

The light transmissive section 118 may form a portion of an outer surface of the light module 110. The light transmissive section 118 may extend completely around an outer periphery of the light module 110. For example, the light transmissive section 118, in one embodiment, may extend partially around the base 114, and in another example, may extend completely around the base 114. In addition, one or more light transmissive sections 118 may also be provided on an end face 117 of the base 114.

An outer surface of the light transmissive section 118 may be flush with an outer surface of the base 114. In some examples, the light transmissive section 118 may include a plurality of light transmissive sections 118.

The light source 112 may be housed within the base 114. The light source 112 is configured to emit light to be transmitted through the light transmissive section 118. In some examples, the light source 112 may be co-located with the light transmissive section 118 such that the light source 112 extends around the periphery of the light module 110 and emits light through the light transmissive section 118. The light transmissive section 118 may include, for example, a translucent or transparent material over the light source 112, such that light is emitted through the translucent or transparent material.

In some instances, the vehicle bumper 100 of the present embodiments is an aftermarket vehicle bumper, configured for installation sometime after sale from the original equipment manufacturer. That is, the vehicle bumper 100 may not a factory installed, original equipment bumper. Instead, the present vehicle bumper may be installed over, or to replace, the original factory bumper, as an aftermarket accessory. As such, the present vehicle bumper 100 may have dimensions extending beyond those of the factory original bumper. For example, the present bumper 100 may extend forward beyond a forward extent of the factory original bumper, below a lower extent of the factory original bumper, and/or laterally beyond a left and/or right side extent of the factory original bumper (i.e., the present vehicle bumper 100 may be wider than the factory original bumper).

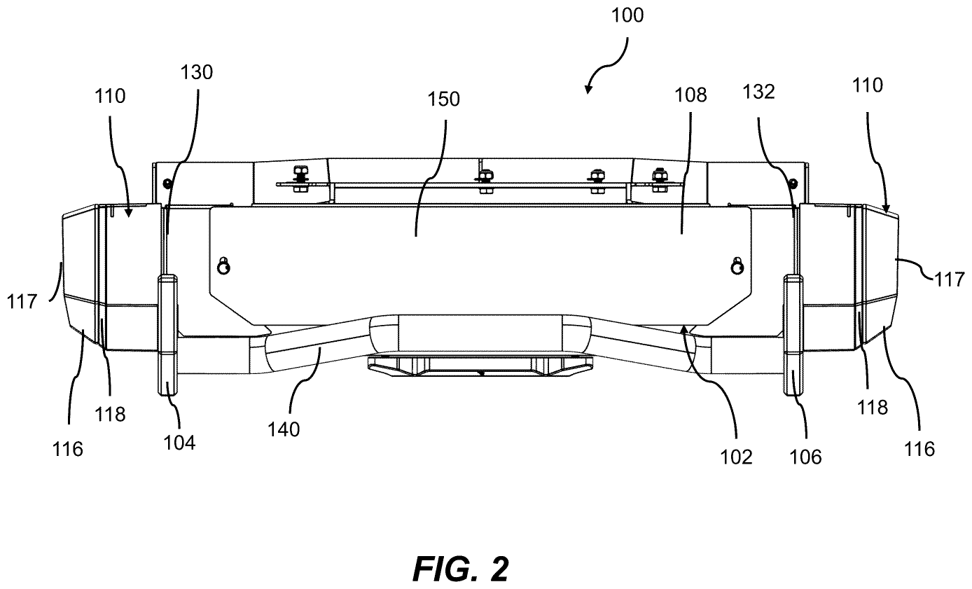

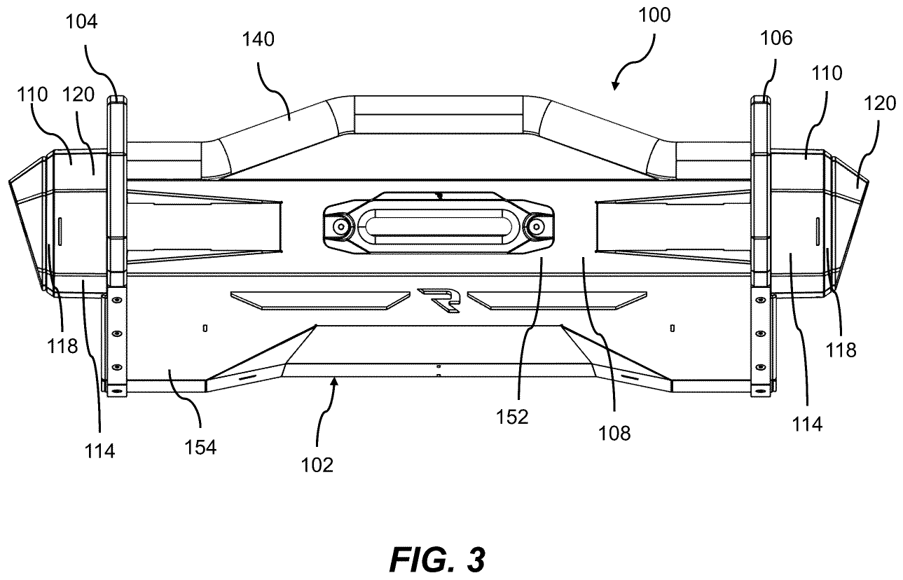

As shown in the respective top and front views of the bumper 100 in FIGS. 2 and 3, the light module 110 may include a first light module 110 arranged at a first lateral end 130 of the bumper body 102 and a second light module 110 arranged at a second lateral end 132 opposite to the first lateral end 130. The first and second supports 104, 106 and the cross body 108 may be arranged laterally between the first light module 110 and the second light module 110.

The light module 110 may be removably attached to the bumper body 102. The bumper body 102 may have a mounting surface and the light module 110 may be configured to be attached to the bumper body 102 at the mounting surface. The mounting surface and the light module 110 may include corresponding mating fasteners, and the light module 110 may be attached to the bumper body 102 by engagement of the corresponding mating fasteners. The mounting surface and the light module 110 may include mating electrical connectors such that the light module 110 may be electrically connected to the bumper body 102 via the electrical connectors. The light module 110 may be configured to receive power and/or data via the electrical connectors. In various examples, the light module 110 may be mounted to a lateral end 130, 132 of the bumper body and/or a support 104, 106.

The bumper body 102 may include one or more electrical body connectors configured to be electrically connected to the vehicle and receive power and/or data via the electrical connection. The vehicle bumper 100 may be electrically connected to the light source 112. The power supply may be connected to and/or positioned within the light module 110. In other examples, the light module 110 may be connected directly to a power source or include its own power source.

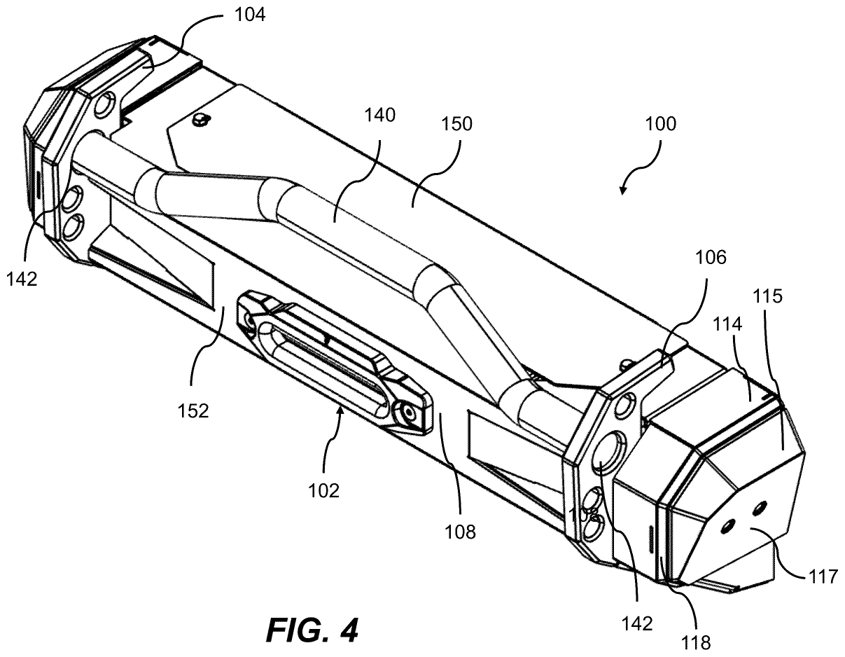

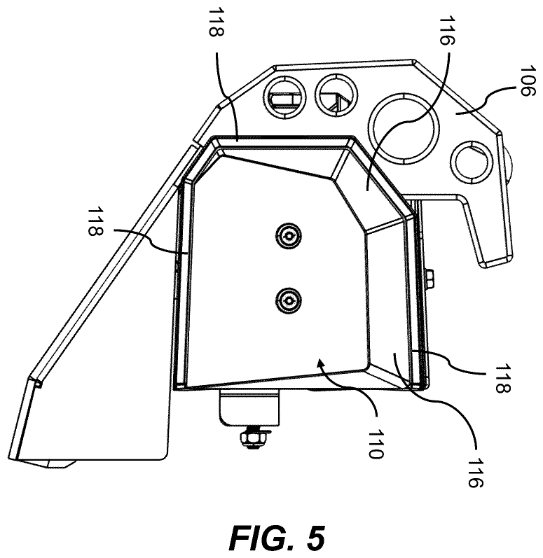

With additional reference to FIGS. 4 and 5, the vehicle bumper 100 may further include a bar 140 extending between and connected to the first support 104 and the second support 106. In one example, the bar 140 is supported by the first and second supports 104, 106. For example, each end of the bar 140 may be secured in an opening 142 of the respective supports 104, 106. The bar 140 may be supported by the supports 104, 106 in any other known, suitable manner as well. The cross body 108 may include an upper surface 150, a front surface 152 below the upper surface 150, and a lower surface 154 below the front surface 152. The bar 140 may add structural rigidity to the bumper 100, provide additional protection to the vehicle and/or serve as an anchor for attaching other accessories or connecting to a rope or winch line, for example.

The first light module 110 and the second light module 110 may be configured to be operated as turn signals. For example, the light modules 110 may receive a signal from the vehicle indicative of a turn signal, and in turn, the light source 112 may be controlled to operate in a blinking pattern at either the left or right side of the vehicle bumper 100. Alternatively, or in addition, the light source 112 on both sides may be controlled to operate in a synchronized manner as hazard lights, in response to receiving a signal indicative of a hazard light signal. In further examples, in addition or as alternatives to those above, the light sources 112 may be operated to be in an “ON” condition to provide auxiliary lighting at the ends of the vehicle bumper 100, for example, to allow an operator or others in the vicinity of the vehicle bumper 100 to more easily discern the ends of the bumper and/or obstacles or objects in close proximity to the vehicle bumper 100.

With reference to FIG. 5, at least a portion 116 of the base 114 may taper inward moving in a lateral outward direction from a position adjacent to the light transmissive section 118 to the end face 117of the base 114. Said differently, the base 114 may decrease in width in at least one direction along a substantially lateral direction from a position proximal to the light transmissive section 118 to a position distal to the light transmissive section 118.

In the illustrated example, a distal end of the base 114 is an end face 117 which forms a lateral end of the vehicle bumper 100. Accordingly, with this configuration, the light transmissive section 118 may be visible not only from front and top views for example, but also from a side view as shown in FIG. 5.

In some embodiments, the base 114 is provided as single part. In other examples, the base 114 may include and end cap section 115 selectively attached to, and removable from base 114 to provide access to the interior of the base 114. In the illustrated example, the at least one tapered portion 116 can be provided on the cap 115 as well as end face 117.

Referring generally to FIGS. 1-5, in some embodiments, a front bumper 100 for a vehicle 10 includes a bumper body 102 connected to the vehicle, a first light module 110 at a first lateral end 130 of the bumper body 102, and a second light module 110 at a second lateral end 132 of the bumper body 102. The first and second light modules 110 each include a light source 112 configured to emit light from the respective light module 110. The first light module 110 and the second light module 110 may be removably secured to the bumper body 102. The first and second light modules 110 each may include a section 118 for transmitting light emitted from the light source 112. The section 118 extends at least partially around a periphery of the respective light module 110. An outer surface of the section 118 may be flush with an outer surface of an adjacent portion of the respective light module. In some examples, the outer surface of the section 118 is flush with a tapered portion 116 of the base 114.

As previously described, for each light module 110, the base 114 may house the light source 112. Light emitted from the light source 112 may be transmitted through the light transmissive section(s) 118 to the external environment. In various embodiments, the light transmissive section 118 may include, for example, one or more openings or slots and/or a light transmissive material. In other examples, the light source 112 may be a cover for a strip (or other shape) of lights installed on the base 114. In some examples, the base 114 may include a groove or slot in which the light source 112 may be arranged and the light transmissive section 118, which may generally be considered an outer surface of the light source 112, can be flush with an outer surface of the base 114. In other examples, the light transmissive section 118 outer surface may be offset, i.e., not flush, with an outer surface of base 114.

In further examples, the light module 110 may include multiple light transmissive sections 118. The light transmissive sections 118 can be arranged at one or more locations spaced from an outer lateral end face of the base 114, at the outer lateral end face, and/or on the outer lateral end face.

It will be appreciated that in the various embodiments herein, in a front view of the vehicle bumper, as shown in FIG. 3, for example, descriptions of a lateral direction refer to a horizontal, left to right, or right to left, direction in the figure. In other words, the lateral direction is the direction extending from one light module 110 (e.g., at the left side in FIG. 3) to the other light module 110 (e.g., at the right side in FIG. 3). The end faces 117 at the outer facing ends of the light modules 110 may form the left and right lateral ends of the vehicle bumper 100. In addition, description of a periphery or a peripheral direction of the light module 110, base 114 and the light transmissive section 118, may refer to the direction extending along and around the outer surface of the light module 110 (and/or base 114 and/or light transmissive section 118) generally surrounding a horizontal axis extending in the lateral direction. For example, with further reference to FIG. 3, a horizontal axis may extend in the lateral direction from left to right in the figure, while the peripheral direction may extend along the outer surface of the light module 110 into and out of the page and vertically up and down, or portions thereof, to surround or partially surround the horizontal axis.

Alternatively, or in addition, the base 114 may be made of multiple sections connected together. For example, the base 114 may have a first section and second section configured to be connected to one another. For example, the second section may be provided as an end cap 115 described above, the light source 112 and/or the light transmissive section 118. Thus, in some examples, the second section 115 may include tapered portion 116, or have a decreasing in width at least one direction moving laterally out from the light transmissive section 118 to the end face. In some examples, the first section 114 and the second section 115 are spaced apart on the outer surface 120 by a lateral width of the light transmissive section 118. Alternatively, or in addition, the light transmissive section 118 may be arranged along the outer periphery at the outer lateral end of the light module 110, to substantially surround the end face 117. Alternatively, or in addition, one or more light transmissive section 118 may be provided on the end face 117. In illustrated examples, the light transmissive section 118 includes at least a portion extending on the outer surface 120 of the light module 110 in a peripheral direction. The first section 114 may optionally be formed with any suitable constant width, and the light transmissive section 118 may be formed having substantially the same outer dimensions to be flush with the outer surface of the first section 114. In some examples, a proximal end of the second section 115 (adjacent to the light transmissive section 118) may have a smaller width than a distal end of the first section 114 (adjacent to the opposite side of the light transmissive section 118). In such an example, a step may be formed from the outer surface of the light transmissive section 118 to an outer surface of the second section 116 at the distal portion. The light transmissive section 118 may be provided at the step. Alternatively, or in addition, the light transmissive section 118 may be beveled, ramped, curved or the like and the outer surface of the light transmissive section 118 may be flush with the outer surface of the second section 115 or tapered portion 116.

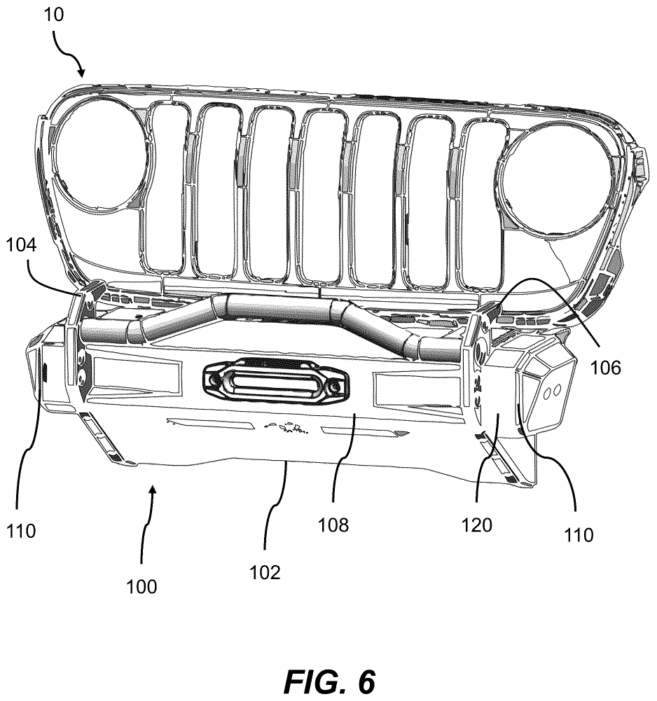

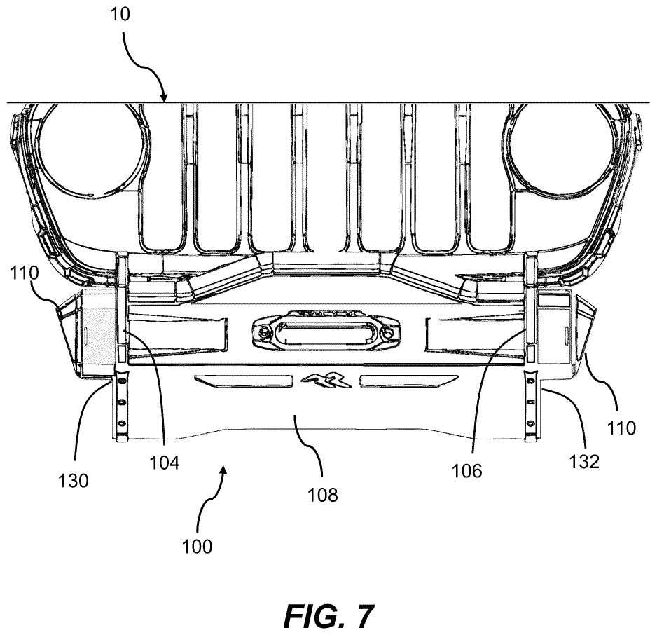

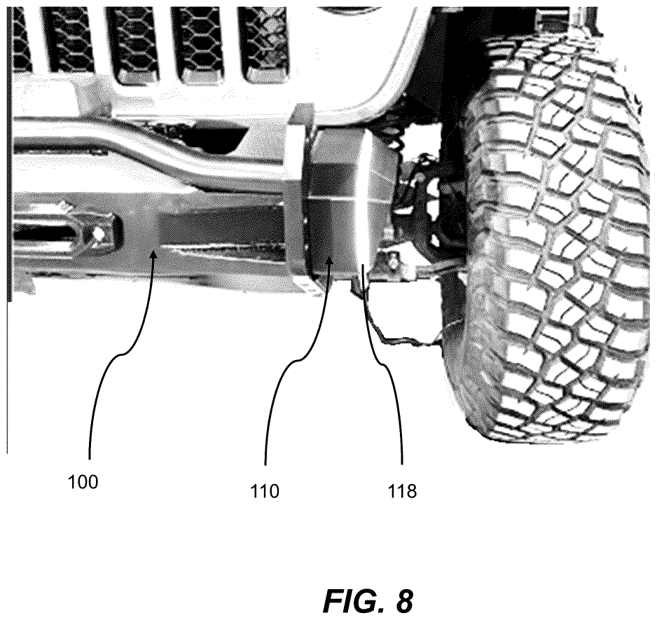

Referring now to FIGS. 6-8, in some embodiments, an aftermarket front bumper 100 for a vehicle 10 is configured to be mounted to a front portion of the vehicle 10. The aftermarket front bumper 10 is described in the examples above. The front bumper 100 includes bumper body 102 having an installation surface configured to accommodate installation on a corresponding surface of the vehicle 10. A light module 110 is removably connected to the bumper body 102 and includes a light transmissive section 118 through which light is transmitted from a light source. The light transmissive section 118 forms less than all of an outer surface 120 of the light module 110. The light transmissive section 118 extends at least partially around a periphery of the light module 110, such that emitted light is visible around some of or the entire periphery of the light module 110.

In some examples, the light transmissive section 118 may be a closed loop extending around the periphery of the base 114, but it will be appreciated that other configurations are envisioned. For example, the light transmissive section 118 may be provided in an open loop extending partially around the periphery of the base 114, a spiral configuration, and/or a plurality of discretely formed light transmissive sections arranged in a predetermined pattern, including but not limited to a loop, spiral, logo, a mesh-like pattern, and other suitable shapes and patterns. In some examples, the light transmissive section(s) 118 may extend around the top, front and lower surfaces of the base 114. The light transmissive section(s) 118 may be omitted from a rear surface of the light module 110, for example, to reduce the likelihood of glare to the vehicle operator.

According to various examples, a vehicle 10 may include a vehicle body the vehicle bumper of the embodiments above. The vehicle bumper is connected to the vehicle body. In other examples, a vehicle 10 includes a vehicle body and the front bumper of the embodiments above. The front bumper is connected to the vehicle body. In further examples, a vehicle includes a vehicle body and the aftermarket front bumper of the embodiments above. The aftermarket front bumper may be connected to the vehicle body.

The foregoing description is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle bumper, comprising:
a bumper body having a first support, a second support laterally spaced from the first support and a cross body positioned between the first support and the second support; and
at least one light module comprising a light source, a base, and a light transmissive section through which light emitted from the light source is transmitted.

2. The vehicle bumper of claim 1, wherein the at least one light module includes a first light module arranged at a first lateral end of the bumper body and a second light module arranged at a second lateral end opposite to the first lateral end.

3. The vehicle bumper of claim 2, wherein the first and second supports and the cross body are arranged laterally between the first light module and the second light module.

4. The vehicle bumper of claim 1, wherein the light transmissive section has different light transmission properties than the base.

5. The vehicle bumper of claim 4, wherein the light transmissive section includes a transparent material.

6. The vehicle bumper of claim 4, wherein the light transmissive section includes a translucent material.

7. The vehicle bumper of claim 4, wherein the light transmissive section includes a light diffracting surface.

8. The vehicle bumper of claim 1, wherein the light transmissive section forms a portion of an outer surface of the light module.

9. The vehicle bumper of claim 1, wherein the light transmissive section extends completely around an outer periphery of the base.

10. The vehicle bumper of claim 1, wherein an outer surface of the light transmissive section is flush with an outer surface of the base.

11. The vehicle bumper of claim 1, wherein the light source is housed within the base.

12. The vehicle bumper of claim 1, wherein the light source is co-located with the light transmissive section such that the light source extends in a direction around the periphery of the light module and emits light through the light transmissive section.

13. The vehicle bumper of claim 1, wherein the light transmissive section includes a plurality of light transmissive sections.

14. The vehicle bumper of claim 1, wherein the base apers inward moving in a lateral outward direction from a position adjacent to the light transmissive section to an end face of the base.

15. The vehicle bumper of claim 1, wherein the light module is removably attached to the bumper body.

16. The vehicle bumper of claim 1, wherein the bumper body includes one or more electrical body connectors configured to be electrically connected to the vehicle and receive power and/or data via the electrical connection.

17. The vehicle bumper of claim 1, further comprising a power supply electrically connected to the light source.

18. The vehicle bumper of claim 1, wherein the vehicle bumper further includes a bar extending between and connected to the first support and the second support.

19. A front bumper for a vehicle, the front bumper comprising:
a bumper body connected to the vehicle;
a first light module at a first lateral end of the bumper body; and
a second light module at a second lateral end of the bumper body,
wherein the first and second light modules each include a light source configured to emit light from the respective light module.

20. An aftermarket front bumper for a vehicle, the front bumper configured to be mounted to a front portion of the vehicle, the front bumper comprising:
a bumper body having an installation surface configured to accommodate installation on a corresponding surface of the vehicle; and
a light module removably connected to the bumper body, the light module having a light transmissive section through which light is emitted, wherein the light transmissive section forms less than all of an outer surface of the light module.
